(19) United States
(12) Patent Application Publication
(10) Pub. No.: US 2018/0098523 A1
(43) Pub. Date: Apr. 12, 2018

(54) System and Method for Managing Healthcare and Pet Identification Data through a Single Rabies Tag

(71) Applicant: Master Vet Products, Manheim, PA (US)

(72) Inventor: Todd Basom, Manheim, PA (US)

(21) Appl. No.: 15/728,678

(22) Filed: Oct. 10, 2017

Related U.S. Application Data
(60) Provisional application No. 62/406,075, filed on Oct. 10, 2016.

(51) Int. Cl. A01K 11/00; G06Q 50/24; G06F 17/30

(52) U.S. Cl. CPC A01K 11/008; A44C 5/0015; G06F 17/30876; G06Q 50/24

(57) ABSTRACT

The present patent application is directed to a system for owners of domestic animals whereby a single authorized smart rabies tag immediately and in real-time provides pet information to a mobile device through a QR code located on the rabies tag. These single Smart Rabies Tags provide comprehensive pet information including health care data and allow real-time access for locating lost pets. The system also includes access through an individual pet website. When combined with microchip systems, the multifaceted platform eliminates many of the current problems associated with current tag systems or microchip systems.

### CROSS-REFERENCE TO RELATED APPLICATIONS

This application claims the benefit of U.S. Provisional Application No. 62/406,075, filed Oct. 10, 2016 and incorporated by reference in its entirety.

### FIELDS OF THE INVENTION

The present application relates to a system and method for identification of lost pets and the management of individual pet healthcare data. More particularly, the present application relates to a system and method to provide real time information related to an individual pet's identification and healthcare data, including rabies status, using a single smart rabies tag and wireless communication devices.

### BACKGROUND

A domestic animal is an animal such as a dog or horse that has been tamed and kept by humans as a work animal, food source or pet, especially a member of those species that have, through selective breeding, become notably different from their wild ancestors. While pets form a much closer bond with humans than other animals, there are various reasons, such as livestock, working animals or sport animals, for maintaining information or data necessary to identify and maintain healthcare and individual information on a specific domestic animal.

According to the American Humane Society approximately 5,000,000 to 7,000,000 animals enter animal shelters annually in the United States. Of these, approximately 3,000,000 to 4,000,000 are euthanized. Many of the animals that animal control captures are lost pets, less than 2% of lost cats and only around 15% to 20% of lost dogs are reunited with their owners.

Several methods have been used to resolve some of the problems with connecting the human with their pet, all with different drawbacks. The earliest known method is to use an animal information tag with the pet's name and address written or engraved on the tag. The amount of information that can be legibly displayed by the tag is, however, limited and the tag is unable to apprise the owner of the status of their pet. The information physically engraved on the tag is often insufficient to ensure reliable recovery of the pet.

Other methods encode more extensive information about a pet within a microchip which is implanted in the animal. Such chips can also be used to locate the animal. Micro-chipping is routinely done with all pet adoptions or recommended for puppies when they are brought to the veterinarian for the first time. Micro-chipping is worthless if the pet owners never register their pet with a microchip registry or do not know where to find the number. Further because of the size of the microchips, they have very little capacity to carry very much information other than species, breed, age, and pet owner contact information.

Other devices incorporate a global position system (GPS) device on the animal in order to track and locate the animal. However, GPS modules are generally expensive (monthly service fee) and power consuming. This type of devices cannot stay activated over the days or sometimes even hours needed to locate the animal.

In addition, recent designs of animal tags utilize one-dimensional bar-codes to encode information about the animal, see U.S. Pat. No. 7,578,433. Other disclosures describe an information tag such as a tag, badge, pin or other object worn by the pet or affixed to a collar that bears a scannable two-dimensional bar-code unique to the animal. The two-dimensional barcode is a QR code scannable by a variety of suitable handheld electronic devices, see US 20140306005

Cats and dogs are required by law to have rabies vaccination tags demonstrating that the animal has been properly vaccinated. Current requirements by the American Veterinary Medical Association (AVMA) call for a rabies vaccination to be administered by a veterinarian at least once every three years to dogs and cats. When vaccinated, the veterinarian issues a numbered rabies tag to the pet owner with the shape and color of the tag designated by the AVMA to represent the particular year of vaccination. This allows a dog control officer or veterinarian to see when that dog was vaccinated for rabies at a safe distance before any interaction with the animal.

Veterinarians order rabies tags in estimated quantities from distributors or tag manufacturers that are made to provide the designated color and shape for a specific year. Current rabies tags are usually printed with the year, the tag number, the vet clinic's name and clinic's phone number. If the pet becomes lost, one can trace the pet back to the owner by calling the veterinary clinic and having them look up the rabies tag number, however this process involves multiple physical steps and a prolong period between finding the pet and return to its owner.

When a pet is found with only a rabies vaccination tag, additional information is not readily available. The information on the vaccination tag will vary between cities, counties and states, but generally the information usually tracks back to the city or even the specific vet clinic where the pet was vaccinated. Using the phone number on the tag and the ID number, someone who finds the pet will be able to track down the veterinarian who administered the vaccine and through the veterinarian's records locate the owner and owner's address. There is no other log kept anywhere else. Consequently, all data and records related to the administration of the vaccine is held by the veterinarian who looks up the information based upon the tag number along with the year represented from the tag. The tag number, and more specifically, the rabies vaccine certificate provides the only evidence of the lost pet having a rabies vaccine.

While using multiple tags in addition to the rabies tag on a pet may increase the available pet information, there is still the delay in the return to pet owners when the pet is lost. Pet owners do not like to have multiple tags on their pets where there would be additional noise and extensive wear from the rattling of the tags. Given the large number of lost animals in the United States, the difficulty in rapidly accessing animal records, the inconvenience of multiple tags, and the need to provide animal owners with the most current information on pet care and related care products, there exists a growing need for a system that can easily address these problems and that system is described herein using a single rabies tag.

Further, a system is described that links the single rabies tag platform with a microchip platform to aid in locating lost pets, accessing health records through a mobile device in real time, send text and email alerts, and create a website for each pet through an application on a smartphone or other mobile device.

The present invention allows owners to become a more engaged pet owner who is better prepared to locate their lost pet and also take a more active role in the health of their pet.

### SUMMARY

The present patent application is directed to a system for owners of domestic animals whereby a single authorized smart rabies tag immediately and in real-time provides pet information from five different data groups (5-in-1 MVP ID Rabies Tag). These groups include (a) authorized rabies tag with licensed shape, year issued, color and rabies tag number; (b) pet owner information such as, but not limited to, name, phone number or email; (c) pet healthcare data such as, but not limited to, the name of the pet, breed, color, sex, license number, insurance number; (d) the medical history such as, but not limited to, spayed or neutered, vaccinations, allergies, medications, prescriptions, nutritional requirements; and (e) a lost pet recovery notification process that sends a text or email alert to the pet owner once the QR code on the smart rabies tag is scanned by another handheld device. In addition, the owner's handheld device can provide vaccination notification and other healthcare alerts based on the information stored in the data groups. The system further utilizes the owner's personal smartphone to provide a means for communicating pet-personalized advertising and marketing information to the owner of the most relevant products or services for the owner's pet. Taken together these aspects provide both a lost pet locator system and a real-time digital health records access system. This information is further incorporated into the pet's individual website based on a single URL address and the pet's 5-digit code.

When combined with a microchip system, the two systems provide a multifaceted platform that will maximize the ability to locate a lost pet, minimize the time required to bring them home, allow for access to health records through a mobile device, send text and email alerts, and utilize all the advantages of having an individual pet's web site.

### DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1 are images of designated rabies tag shapes and color, each representing a specific year for the pet's vaccination.

FIG. 2 is a flow chart illustrating access to pet data by third parties and pet owners through the QR code using a mobile device.

FIG. 3 is a flow chart illustrating the multifaceted platform that incorporates the single tag system with any microchip system.

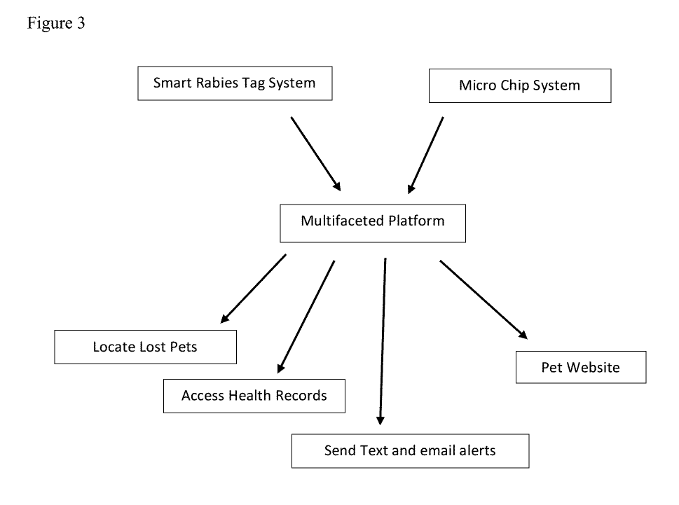

### DETAILED DESCRIPTION OF THE INVENTION

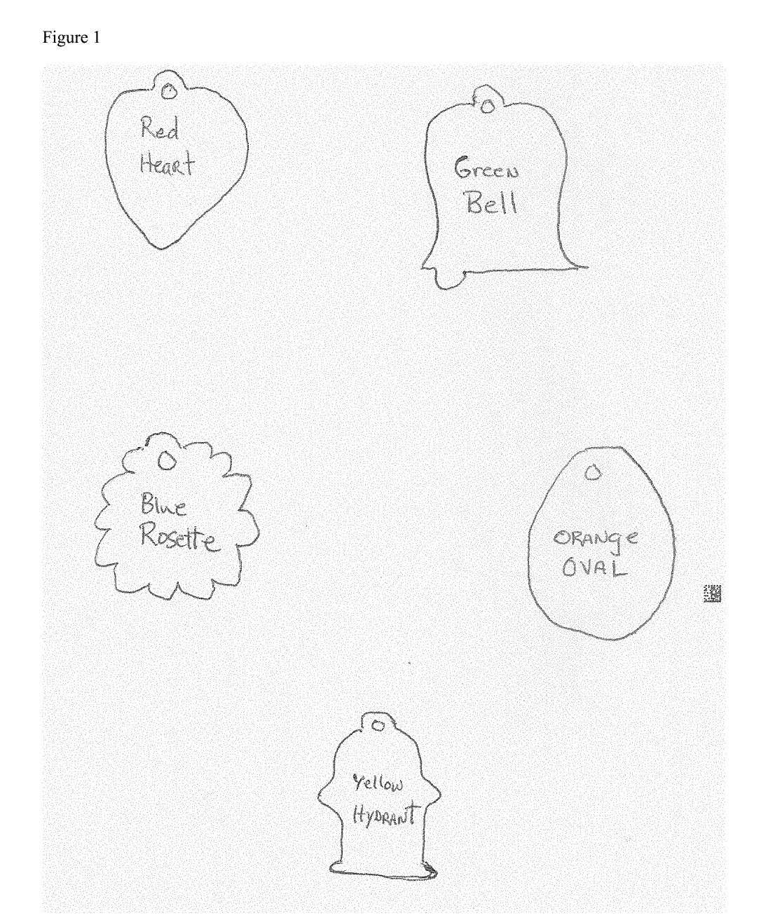

The present invention provides a comprehensive pet information-based system through an authorized smart rabies tag. Authorized smart rabies tags are coded by their shape and color to provide animal control agents that find a lost pet a means to rapidly assess the vaccination year of the pet at a safe distance before approaching the pet. Smart rabies tags are specifically designed by shape and color to reflect the year that the vaccination was provided. Examples include a heart shape, hydrant shape, bell shape, rosette shape and oval shape for the year issued (see FIG. 1). The smart rabies tag further contains a phone number, corresponding color, a website and ID number embossed on the tag.

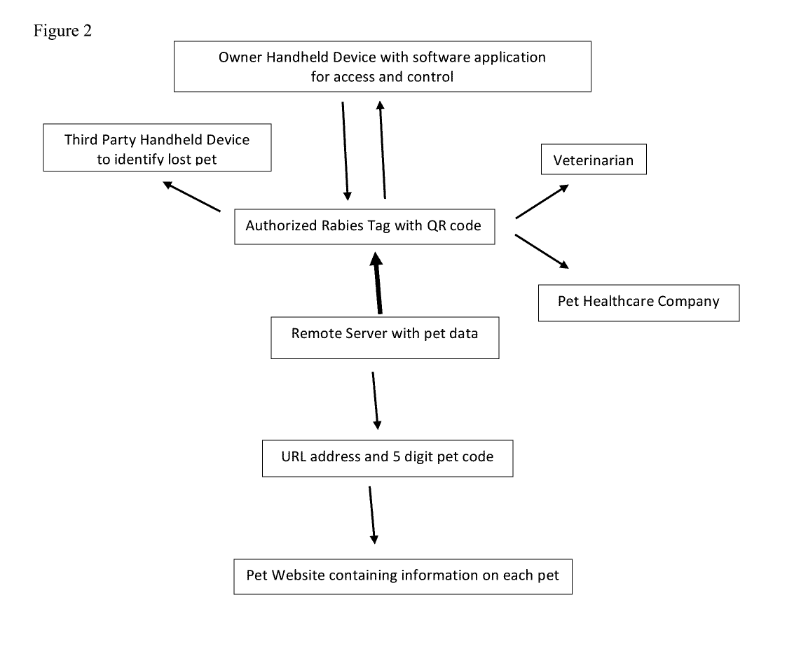

The present system incorporates the authorized smart rabies tag with an embedded QR code which is can be scanned by a variety of suitable handheld electronic devices such as a smartphone. A remote server is configured to store information that corresponds with the smart rabies tag and it's embedded QR code (see FIG. 2). A software application is installed on the owner's handheld device and configured to provide a user interface and establish a connection with the information contained on the remote server. The method involves scanning the unique identification QR code on the smart rabies tag with a handheld device having a wireless communication means to a remote server or to directly distinguish the tag from a plurality of tags. The handheld device is configured to establish a connection with the tag and trigger a predetermined routine for locating a lost pet and/or accessing the pet's healthcare and identification data.

One embodiment incorporates a process for locating and reuniting a lost pet with its owner. If the pet becomes lost, the owner is able to activate a lost pet recovery routine through a web site such that if a third party's handheld device is used to scan the tag, the predetermined routine is structured to provide limited information from a remote server to the scanning device in order to reconnect the pet with the owner such as contact information, phone number, or email. The predetermined routine further incorporates a lost pet recovery notification process that sends a text or email alert to the pet owner immediately upon scanning by the third party's device (see FIG. 2).

The lost pet recovery notification process can further provide the GPS coordinates of the scanning handheld device to the owner. Accordingly, a predetermined routine for locating a lost pet may further include uploading a set of GPS coordinates from the scanning handheld device's location to a remote server; sending the set of GPS coordinates to the owner's handheld device by the remote server; and displaying on the owner's handheld device a proximate position of the lost pet based on the set of GPS coordinates from the scanning handheld device.

If the owner's handheld device is used to scan the tag, a predetermined routine provides individual pet healthcare data such as the name of the pet, breed, color, sex, license number, or insurance number. The predetermined routine also provides data on the medical history such as, spay or neuter status, vaccinations, allergies, medications, prescriptions, or nutritional requirements.

Thus, another embodiment provides a means for an owner to access a pet's complete health data including the name of the pet, a picture, the breed, color, sex, temperament, license number, insurance policy number and the pet's medical history including spay and neuter information, vaccinations, allergies, medications, prescriptions and special diets. In this embodiment, the unique identification code on the smart rabies tag is scanned by the owner's handheld device, or any scanning device designated by the owner which then downloads the appropriate healthcare and identification information stored on the remote server. Alternatively, the same information can be obtained through access by the owner from the pet's website, based on a central URL address and the pets 5 digit code (see FIG. 2).

In a still further embodiment, the owner's handheld device may be configured to receive information associated with the rabies vaccination maintenance, healthcare alerts and other events commonly needed in maintaining proper pet care (see FIG. 2). A reminder text system is used where, for example, an alert email is sent when the pet's rabies vaccination is due or other healthcare notifications. The remote server may be configured to provide notifications by the veterinary clinic for routine check-ups or healthcare news information regarding the owner's pet. Alerts or notifications may be provided through a pop up message or a ringtone sound. The means for alerting the owner may include an email message, text message, an instant message, or a telephone call (see FIG. 2).

The data collected for each pet such as, but not limited to, whether the animal has been spayed or neutered, vaccinations, allergies, medications, prescriptions, or diet provides a large database of pets and pet owner information that can be analyzed to create a personalized pet-portfolio for pet product companies such as dog food manufacturers and more succinctly target consumer needs. For example, the present invention is useful in targeted advertising to pet owners where distributors can easily up sell their own offerings by presenting advertisements for products which are upgrades to products or services previously purchased by the owner while avoiding presenting advertisements for services to which the owner has already purchased.

In order to target relevant advertising content to select customers, it is important for advertisers to understand the factors that are helpful in targeting advertisements suitable for individual customers. Here, data is collected on the pet and pet owner. This information allows advertisers to process pet and pet owner data collected and provide customized or selected advertising content based on the pet and pet owner particular habits and needs (see FIG. 2).

A further embodiment of the present invention combines current microchip systems with the single smart rabies tag system of the present invention to provide a multifaceted platform that resolves the problems associated with individual systems and allows pet owners to be more engaged as a pet owner with easier access to the health records of their pet and be better prepared if their pet gets lost.

With a tag system there is always a possibility that the pet will lose the collar and the attached tags. In this scenario, the GPS pet locator system has little value. Additionally, microchips must be implanted in the animal and registered by the pet owner through a microchip registry. Microchips do have drawbacks like finding a place that has a reader and also pet owners sometimes fail to register their pet with the microchip registry which makes the chip worthless. Because of their size, these microchips have a very limited amount of information, primarily species, breed, age, and pet owner contact information.

However, when these two systems are combined as disclosed in the present invention, the problems associated with each individual system are reduced. Lost pets are easily found through the single smart rabies tag and confirmed with access to the microchip system. Lost pet having only the microchip system are connected with their owner through the interface with the smart tag system (i.e. website, text message, or email). The multifaceted platform allows access to the pet's health records, similar to the single smart tag system but also allowing access through the microchip system.

The single smart tag system alone or when combined with a microchip system in a multifaceted platform provides a convenient and cost-effective means for pet owners and creates the ability for targeted advertisements to pet owners. The system described in the present invention complies with all state rabies law requirements and at the same time provides a complete profile of the pet along with relevant medical information using only a single smart rabies tag. The system allows the pet owner to become more involved with their pet's care by having all of their pet's vital healthcare information at their fingertips, accessing all the data through their smartphone or other handheld device. The present invention provides the veterinarian a more pro-active way to communicate with pet owners regarding individual pet care over prior methods such as sending post cards or phone calls when vaccinations and routine check-ups are due. Finally if a pet does become lost, the present invention is capable of providing 24/7 notification service and GPS location to the owner in real-time.

While the present patent application has been shown and described with particular references to a number of embodiments thereof, it should be noted that various other changes or modifications may be made without departing from the scope of the present invention.

I claim:

1. A system for accessing pet data in real time comprising:
a. a rabbis tag having a QR code;
b. a first mobile device capable of reading the QR code;
c. a wireless communication system; and
d. a remote storage device wherein the QR code allows the mobile device to access pet data stored in the remote storage device.

2. The system in claim 1 wherein the remote storage device contains at least one data group.

3. The system in claim 2 wherein the remote storage device contains 5 data groups.

4. The system in claim 3 wherein the 5 date groups are a rabbis tag authorization, pet owner information, pet healthcare, medical history, and a lost pet recovery notification.

5. The system of claim 4 wherein the rabbis tag authorization is selected from a group consisting of a tag shape, year issued, a color, a tag number, and combinations thereof.

6. The system of claim 4 wherein the pet owner information is selected from a group consisting of at least one name, at least one phone number, at least one email, and combinations thereof

7. The system of claim 4 wherein the pet healthcare is selected from a group consisting of at least one name of the pet, breed, color, sex, license number, insurance number, and combinations thereof

8. The system of claim 4 wherein the medical history is selected from a group consisting of a spay or neutered status, vaccinations, allergies, medications, prescriptions, nutritional requirements, and combinations thereof.

9. The system of claim 4 wherein the lost pet recovery notification sends at least one text or email alert to the pet owner when the QR code on the rabbis tag is scanned by a second mobile device.

10. The system of claim 1 wherein the first mobile device alerts a user to notifications selected from a group consisting of vaccinations, tic and flee treatments, therapeutic treatments, micturition and defecation times, veterinary clinic visits, healthcare news specific for the pet, and combinations thereof

11. The system of claim 1 wherein the first mobile device provides pet-personalized advertising.

12. The system of claim 1 further having a website for a pet comprising:
a. A single URL address; and
b. A 5-digit access code wherein the code allows access to the pet data stored in the remote access storage device.

13. The system of claim 1 further having a means to access a pet microchip system.

14. A method for locating a lost pet by an owner comprising:
a. activating a lost pet recovery notification routine using a system of claim 1 wherein a first mobile device reads a QR code on a rabbis tag;
b. scanning the rabbis tag with a second mobile device;
c. sending at least one text or email alert to the first mobile device of the second mobile device location when the rabbis tag is scanned by the second mobile device; and
d. providing contact information of the owner to the second mobile device.

15. The method of claim 14 further comprising:
a. uploading GPS coordinates of the second mobile device to a remote server; and
b. displaying the proximate position on the of the second mobile device.
